(19) United States
(12) Patent Application Publication
(10) Pub. No.: US 2021/0327121 A1
(43) Pub. Date: Oct. 21, 2021

(54) DISPLAY BASED MIXED-REALITY DEVICE

(71) Applicant: Sirisilp Kongsilp, Bangkok (TH)

(72) Inventor: Sirisilp Kongsilp, Bangkok (TH)

(21) Appl. No.: 17/230,219

(22) Filed: Apr. 14, 2021

Related U.S. Application Data
(60) Provisional application No. 63/010,260, filed on Apr. 15, 2020.

(51) Int. Cl. G06T 15/20; G06F 3/01; G06T 5/00; G06T 17/00; G06F 3/0346; G06T 19/00; G06F 3/0354; G02B 30/00; G02B 27/00

(52) U.S. Cl. CPC G06T 15/20; G06F 3/012; G06T 5/002; G06T 17/00; G06T 2200/24; G06T 19/006; G06F 3/03543; G02B 30/00; G02B 27/0093; G06F 3/0346

(57) ABSTRACT

A display based mixed-reality device for a viewer to view an adjustable holographic image of an object, comprises a first computer having a display, a first camera, and a processor having a data set used for displaying the adjustable image on the display. A tracker of the viewer tracks a position of the viewer to create position data corresponding to a face of the user, wherein the position data is compared to reference data from a facial database to obtain the viewer position. The adjustable image of the object is continuously adjusted in response to a change in the viewer position.

This patent application claims priority benefit of U.S. provisional patent application 63/010,260, filed on Apr. 15, 2020.

### FIELD OF THE INVENTION

This invention relates to a computer which generates and displays holographic images, and more particularly to a simplified, easy to use display based mixed-reality device for displaying and continuously updating holographic images.

### BACKGROUND OF THE INVENTION

Fish Tank virtual reality (FTVR) is a term first used in a 1993 paper to Ware et al in the Proceedings of the INTERACT'93 and CHI'93 conference on Human factors in computing systems (pp. 37-42). ACM. Fish Tank VR, or FTVR refers to a stereo image of a three-dimensional (3D) scene/image or a person/object viewed on a monitor of a computer. Typically, FTVR uses a perspective projection coupled to a head position of the observer/user. The initial design in Ware et al used unwieldly headgear to track the movement of the user.

Since then several other developments in FTVR have occurred. For example, following up on the Ware et al paper, in 1995 Rekimoto published: “A vision-based head tracker for fish tank virtual reality-VR without headgear”, in the Proceedings of Virtual Reality, Annual International Symposium '95 (pp. 94-100). IEEE. Rekimoto discloses a two-part process for making a perspective-corrected image by adjusting the images based on the position of the user using a single camera. A camera on the computer measures a position of the user, typically the head of the user of the computer, in real time. The position of the user is measured through a combination of template matching and image subtraction. Image subtraction consists of removing a background image from a captured image to enhance quality. Template matching in Rekimoto includes storing a partial template of a face of the user and treating the head as a single point in 3D space, working off a position in the middle of the forehead.

However, the known technologies are relatively slow and produce images with ghosting, and typically does not practically provide real time adjustment of holographic images. It would therefore be desirable to provide an enhance display based mixed-reality device for selection task and presentation of an editable 3D image which enhances the user's experience of a holographic image.

### SUMMARY OF THE INVENTION

In accordance with a first aspect, a display based mixed-reality device for a viewer to view an adjustable holographic image of an object is provided, and comprises a first computer having a display, a first camera, and a processor having a data set used for displaying the adjustable image on the display. A tracker of the viewer tracks a position of the viewer to create position data corresponding to a face of the user, wherein the position data is compared to reference data from a facial database to obtain the viewer position. The adjustable image of the object is continuously adjusted in response to a change in the viewer position.

From the foregoing disclosure and the following more detailed description of various embodiments it will be apparent to those skilled in the art that the present invention provides a significant advance in the technology of display based mixed-reality devices. Particularly significant in this regard is the potential the invention affords for providing an enhanced user experience, such as, for example, providing an enhanced viewing experience for a viewer, and/or providing collaboration on a 3-D model in essentially real time between a person at one end of a call and a user using the computer at the other end of the call. Additional elements and advantages of various embodiments will be better understood in view of the detailed description provided below.

### BRIEF DESCRIPTION OF THE DRAWINGS

FIG. 1 is an isometric view of the display based mixed-reality device in accordance with one embodiment, showing a holographic image on a display to a viewer, wherein movement of the viewer causes adjustment of the holographic image on the display.

FIG. 2 is a flow chart showing one way of calculating camera projection matrices, a focal distance and a depth of field of a virtual camera's parameters (for displaying the holographic image on the display) in accordance with one embodiment.

FIG. 3 shows another embodiment where a holographic image is projected on a display, wherein the holographic image can be either or both generated remotely and continuously updated, and optionally edited.

FIG. 4 is a flow chart showing one way of creating the holographic image based in part on a 2D image from a camera.

FIG. 5 is an isolated isometric view of a 3D mouse suitable for adjusting a 3D cursor shown on the display, and for interacting with the holographic image on the display.

FIG. 6 is an isolated isometric view of a 3D wand suitable for adjusting the 3D cursor shown on the display, and for interacting with the holographic image on the display.

FIGS. 7-9 show an embodiment of the display based mixed-reality device where the 3D mouse interacts with a 3D cursor in an XY plane and XZ plane respectively, giving the appearance of extending beyond the display of the computer.

FIG. 10 shows use of the 3D wand tracking camera, with a 3D mesh, for tracking a tip of the 3D wand in accordance with an embodiment where the viewer can use the wand without carrying the wand.

FIG. 11 shows a display based mixed-reality device having both a tracking camera (for tracking a position of the viewer) and a local space tracking camera for tracking the 3D wand, as well as the 3D wand.

FIG. 12 shows a schematic of a 3D image of a virtual box compared with a real box when a user is looking from the left side of the display.

FIG. 13 shows a schematic of a 3D image of a virtual box compared with a real box when a user is looking from the right side of the display.

It should be understood that the appended drawings are not necessarily to scale, presenting a somewhat simplified representation of various features illustrative of the basic principles of the invention. The specific design features of the display based mixed-reality device as disclosed here, including, for example, the specific dimensions of the 3D images presented will be determined in part by the particular intended application and use environment. Certain features of the illustrated embodiments have been enlarged or distorted relative to others to help provide clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the display based mixed-reality device disclosed here. The following detailed discussion of various alternate elements and embodiments will illustrate the general principles of the invention with reference to a holographic adjustable image for a viewer. Other embodiments suitable for other applications, will be apparent to those skilled in the art given the benefit of this disclosure.

Various types of images can be presented to a viewer and adjusted in response to movement of the viewer. As used herein, the term holographic image refers broadly to a 3D image which can be adjusted in response to movement of the user (especially the user's head). Examples of such images/holographic images can comprise, for example, an anaglyph based on a 2D display, which is a stereoscopic 3D effect achieved by encoding each eye's image using filters of different (usually chromatically opposite) colors, typically red and cyan. Anaglyph 3D images based on a 2D display typically contain two differently filtered colored images, one for each eye. When viewed through the “color-coded” “anaglyph glasses”, each of the two images reaches the eye it's intended for, revealing an integrated stereoscopic image. The visual cortex of the brain fuses this into the perception of a three-dimensional scene or composition. Another example is a passive 3D display. A passive 3D display works by using polarized lenses that block out certain waves of light to each eye, creating the illusion of depth and enabling a 3D look to the image/motion picture. Similarly, the image may also be an active 3D display. The active display operates by very rapidly alternating between the left-eye and the right-eye image in the same space. Usually, this is done at about twice the frame-rate necessary for continuity of motion (˜120 Hz). Special glasses again must be worn in order to view such images. These glasses have lenses which turn from opaque to transparent in perfect synch with the transformation of the image. The left image is only displayed when the left lens is transparent (and the right one is opaque) and vice versa. Another type of image is suitable for use here is a parallax barrier 3D display, where a parallax barrier is a device placed in front of an image source, such as the display 11, to allow showing the stereoscopic (or multiscopic) adjustable image without the need for the viewer to wear 3D glasses. Still another type of suitable image is a lenticular lens 3D display. A lenticular lens is an array of magnifying lenses, designed so that when viewed from slightly different angles, different images are magnified. The most common example is the lenses used in lenticular printing, where the technology is used to give an illusion of depth, or to make images that appear to change or move as the image is viewed from different angles. Displays with a molded lenticular surface can be used with projection television systems, for example. In this case, the purpose of the lenses is to focus more of the light into a horizontal beam and allow less of the light to escape above and below the plane of the viewer. In this way, the apparent brightness of the image can be increased. Still yet another option for the image is a light field display. In the light field display, the light field is a vector function that describes the amount of light flowing in every direction through every point in space. The space of all possible light rays is given by the five-dimensional plenoptic function, and the magnitude of each ray is given by the radiance. Light fields are typically produced either by rendering a 3D model or by photographing a real scene. In either case, to produce a light field views must be obtained for a large collection of viewpoints. This collection of views will typically span some portion of a line, circle, plane, sphere, or other shape, although unstructured collections of viewpoints are also possible. Other displays suitable for use as the image disclosed herein, including a plurality of images (understood to include holographic motion pictures and other artwork) will be readily understood by those skilled in the art, given the benefit of this disclosure.

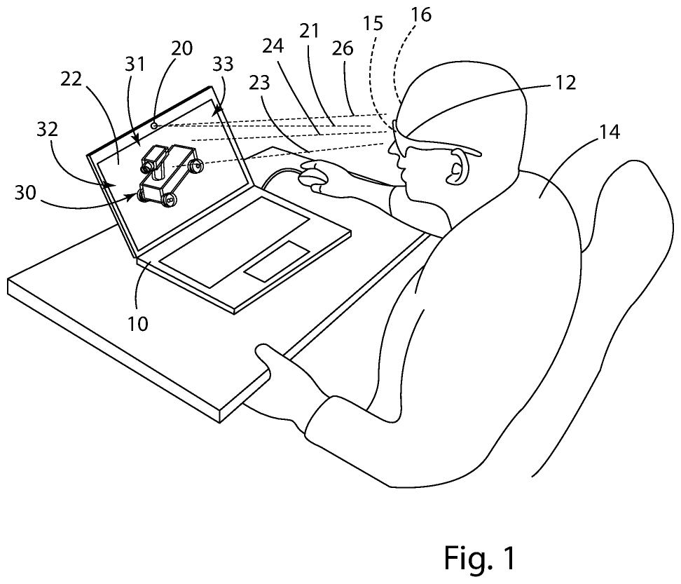

Turning now to the drawings, FIG. 1 shows a display based mixed-reality device in accordance with one embodiment. As used herein, the concept of mixed-reality refers to merging of real and virtual worlds to produce new environments and visualizations, where physical and digital objects co-exist and interact in real time. More specifically, a viewer/user can interact with a holographic image and the holographic image can be adjusted by the viewer, either manually or automatically. FIG. 1 shows an example embodiment where movement of a viewer 14 causes a virtual camera displaying an adjustable image (here rover 30) on a display 22 of a first computer 10 to be adjusted with respect to the viewer. Advantageously the adjustments can be made automatically and continuously (i.e., in real-time) and without the need for additional hardware. The first computer 10 is an electronic device that comprises a processor, a memory and a power source and can comprise, for example, a desktop computer, a smart phone and/or a tablet. The computer has a first camera 20 which continuously captures images of the viewer/user 14 sitting in front of the computer.

In the embodiment of FIG. 1, the image 30 can be a stereoscopic image projected onto the display 22 allowing the viewer 14 to view the image. The processor has a data set corresponding to the adjustable image which is used for displaying the adjustable image 30 on the display. A tracker uses the camera 20 to track a position of the viewer 14. Typically, this involves using the camera to establish or create position data about the user, such as the face of the user, or more specifically the eyes of the user, and can include calculating a distance between the eyes of the user/viewer. In accordance with a highly advantageous element, such viewer position data can be compared to reference data from a facial database to obtain the viewer position, and the adjustable image of the object is continuously adjusted in response to a change in the viewer position. The facial database can be one of several available sources of digital data corresponding to a collection of faces, can include data about the position of the eyes on the face, or an average of positions of eyes on faces. FIG. 1 shows tracer lines 21, 26 from the camera to each of the left eye 15 and right eye 16 of the viewer. Once the viewer position data is determined, the image 30 on the display may be adjusted (changing tracer lines 23, 24 from the image to the viewer's eyes, as if the image was actually a 3D object. Optionally the image or series of images can be moving independent of adjustment in response to change of the user's position. For example, the image of the object presented on the screen may be rotating about an axis and separately adjusted in response to movement of the user. As shown, the viewer is wearing 3D glasses 12 (such as anaglyph glasses) for recombining split images into one by brain. Other ways of adjustment of the adjustable image can be used. For example, the adjustable image 30 has a front side 31, a left side 32 and a right side 33, and as the viewer position moves to the right with respect to the camera 20 the adjustable image 30 can be adjusted to present more of the left side of the adjustable image.

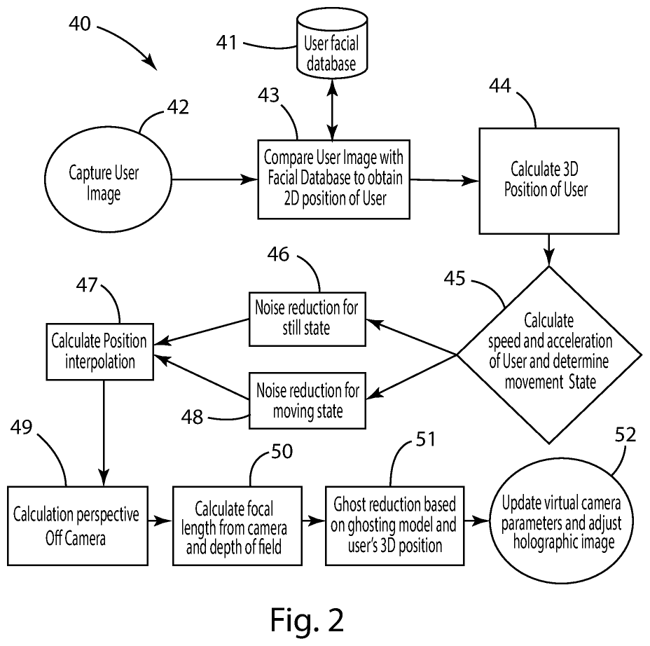

FIG. 2 provides a representative flow chart 40 of a display based mixed-reality device for creating the holographic environment for a computer user/viewer in accordance with an embodiment allowing the user to perceive and interact with computer-generated models as if they exist in front of a computer screen. The holographic image advantageously increases the user's creativity, enhances the user's experience with a greater level of immersion, and ultimately boosts productivity with efficient task performance. The display based mixed-reality device is composed of the 3D display 22 (which can be a combination of active, passive, and/or autostereoscopic technology), the camera 20, the computer 10 and input devices (e.g., a mouse, a 3D mouse, hand motion device or a stylus/wand). Depending on the type of a 3D display, the user may be required to put on 3D eye-glasses and the user can then visualize via the 3D display and use input devices to operate the computer. The camera tracks the users positions enabling the user to get the right perspective images, which makes a display object appear as a holographic object. Facial and visual profile recognition is another advantageous feature where a person's image can be presented to a user. The image can comprise, for example, the person's facial and visual profiles (e.g., interpupillary distance, short-sightedness and long-sightedness). Thereby, the system can adjust cameras' parameters according to the users' profiles. Step 41 shows the capturing position data about the viewer's position by the tracker. This can be 2D data taken by the first camera 20, for example. Next, reference data about faces in step 42 may be compared with the position data from step 41 at step 43 to obtain a 2D position of the viewer position in digital data form. This 2D viewer position data may then, in step 44, be used to calculate a 3D position of the viewer. That is, a 2D viewer position as 2D data is first obtained, and then the viewer position is calculated, and the viewer position is 3D data. From there the viewer position may be used to continuously adjust the adjustable image of the object in response to a change in the viewer's position.

Several additional elements may be added to help improve the response time in updating the image. For example, a noise reducer may comprise multi-state noise filtering which smoothens the virtual cameras' position based on the viewer's movement state (either the viewer is in a moving or still state) and thereby improve the overall user experience. The system offers a dynamic depth of field wherein the person's positions and interactions are used to calculate his/her focal point and depth of field of the virtual camera, and thereby increase the realism of the rendering computer-generated model. For example, in FIG. 2 at step 45 the display based mixed-reality device can calculate a speed and an acceleration of the viewer/user and determine a movement state. Next, at step 46/step 48 one of a pair of noise reducer calculations may be made, depending on whether the viewer is holding still (static) (step 46) or moving (step 48). The noise reducer acts to reduce random variation of either the brightness or the color information in the adjustable image, or both. Typically, these steps are done by sampling the viewer position a number of times per second, and the noise reducer reduces noise by creating interpolated viewer positions between one or more of sampled viewer positions to increase a total number of viewer positions used for adjustment of the adjustable image. Step 47. For example, the total number of viewer positions can be approximately double the number of sampled viewer positions.

Another important aspect is ghost reduction which reduces a ghosting effect when a viewer is using the system. Ghost images are understood herein to mean any undesired image appearing at the image plane of an optical system (that is, on the display); either a false image of the desired object, or an out-of-focus image of a bright source of light in the field of the optical system. An anti-ghoster may be provided as part of the device. To do so, the device uses the viewer's positions and pre-calculated ghost or ghosting pattern model to predict ghosting images that may appear in a single scene. Then the system generates an anti-ghost pattern that would cancel out the ghosting effect when the user uses the system, advantageously reducing an amount of ghosting that the user sees. Returning to FIG. 2, at step 49 a perspective off camera is determined, along with a focal length from the camera, along with a depth of field (step 50). These are used to calculate an estimated ghosting pattern, and at step 51 the estimated ghosting pattern is compared with a model ghosting pattern to generate an anti-ghosting pattern, and the anti-ghosting pattern is applied to the adjustable image to reduce the ghosting effect on the adjustable image.

The multi-state noise filtering feature and dynamic depth of field features help the device provide a higher level of immersion for the user/viewer since the device works by mimicking the projection of images similar to the perception of human eyes. The user facial and visual recognition features allow the system to tailor output images to be more specific for each user, which gives each user higher visual comfort compared with a traditional fish tank virtual reality system.

In accordance with another aspect the display based mixed-reality device may comprise an image creator comprising a basic image of the object, and a 3D reconstructor which uses the basic image to create 3D model data. The 3D model data can be sent to the first computer, and the object is created on the display using the 3D model data. The image creator advantageously can be adopted for display based mixed-reality devices for use with a holo-call feature, for example. This enables two or more users to talk to each other in a holographic environment. A user can record his own holographic videos with the option to play them again at a future time, again in the holographic environment produced by the display based mixed-reality device. An avatar of a person or object is the 3D computer generated model, and this model can be either presented in real time of a holo-call or when making a playback. Alternatively, the object may be an entire person/human, a portion of the person, an entire person's head, or a portion of a person's head. Advantageously, the user can interact with the 3D model, such as changing its appearance. Again, this can be done live or recorded. The Holo-Call feature and the Holo-Playback feature provide a more realistic and entertaining communication experience.

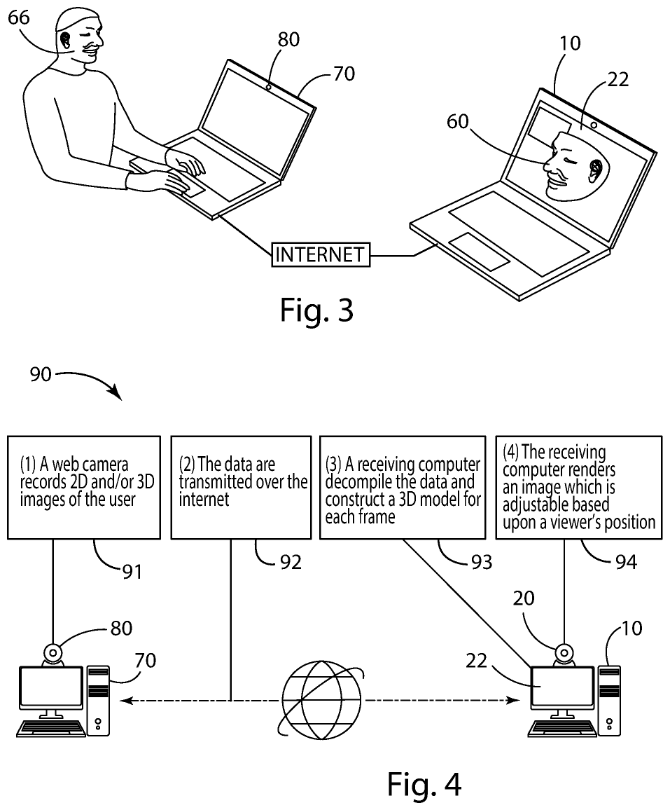

FIG. 3 shows an example of a display based mixed-reality device with the 3D reconstructor. The first computer 10 is operatively connected to second computer 70. The 2^{nd}, networked computer 70 can be provided with a 2^{nd} camera 80. The 2^{nd} camera 80 can take a basic image of an object, such as a person's face 66. The 3D reconstructor creates 3D model data by either comparing this basic image to a standard model of the object to create 3D model data, such that the 3D model data comprises data interpolated from the standard model, or extrapolates the 3D model data from the basic image. The resulting 3D image 60 of the object comprises 3D model data can then be stored or transmitted to another computer, such as the first computer 10. Advantageously, the image can be continuously updated on the display in response to movement of the object.

A representative real time data 3D image of a face of a person transmitted over the internet to a user's computer and display as a perspective-corrected 3D image can greatly enhance communications between parties. As the person moves the perspective-corrected 3D image of the person's face is seen to move on the monitor/display of the computer. The user's computer has a single camera 70, and movement of the user 66 causes adjustment of the perspective-corrected 3D image of the person to account for such movement. Several different algorithms may be used to both generate the 3D model and to track the position of the user's head. For example, the 3D computer generated model of the person, the face of the person, or object may be created using a deep learning neural network with reference to a database of thousands of pictures of faces, for example. In a similar manner another deep learning neural network may be used for facial recognition and tracking. In the preferred embodiments where a single camera is used for each computer, the face of the user may be measured with the camera and compared to a database of thousands of pictures of faces. The 3D model may be generated from 2D data or 3D data and then transmitted in real time to the computer of the user. Optionally the user can interact with the 3D model, such as by editing or otherwise changing features of the image. The interaction can be done using a computer mouse, a glove with sensor or a hand in front of a gesture detection camera or other electronical device. The device disclosed herein can work with a single camera, or be modified to work with a pair of cameras (stereo camera), or with a range imaging camera such as the depth cameras used on an iPhone 11, for example.

As shown in the embodiment showing in FIG. 3, the object is a human head. The standard model can be data corresponding to a standard human head, such as a database of faces stored as digital data. In FIG. 3, the basic image of the head is captured on the second camera on the second computer which is operatively connected to the first computer via an internet connection. The 3D model data can be storable on the processor of the first computer (or on a processor of a second computer) for use on the first display at a later time.

FIG. 4 provides a flow chart 90 showing one embodiment of creating 3D data suitable for creation of a 3D image based on the object. At step 91, and as noted above a camera records a 2D and/or a 3D images of the object, here the face of a user. Next, at step 92 the data is sent to the computer with the display where the 3D image will be displayed (this step would not apply to images created and displayed on the same computer). At step 93 the receiving computer 10 decompile the data and construct a 3D model for each frame. Then, at step 94 computer 10 renders an image which is adjustable based upon a viewer's position, and/or is adjustable based upon movement of the object/face. The 3D constructor can be advantageously used with a holo-call feature in a fish tank virtual reality system or a display based mixed-reality device. After the model is added into a 3D scene in a computer, a fish tank virtual reality system or a display based mixed-reality device can be used to create perspective-corrected 3D image of the 3D scene, thus visualizing the reconstructed 3D model in the process. The 2D image recorded by the camera may be a color image, image of the depth map or other form of 2D data. The reconstructed 3D model may be a point cloud, a set of vertices, a mesh with or without texture or other form of 3D data. Making the adjustable image can be independent of the adjustability of the image.

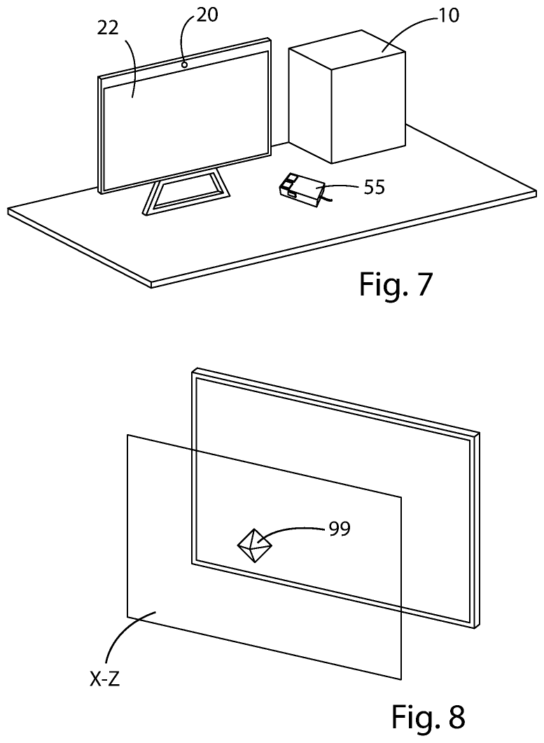

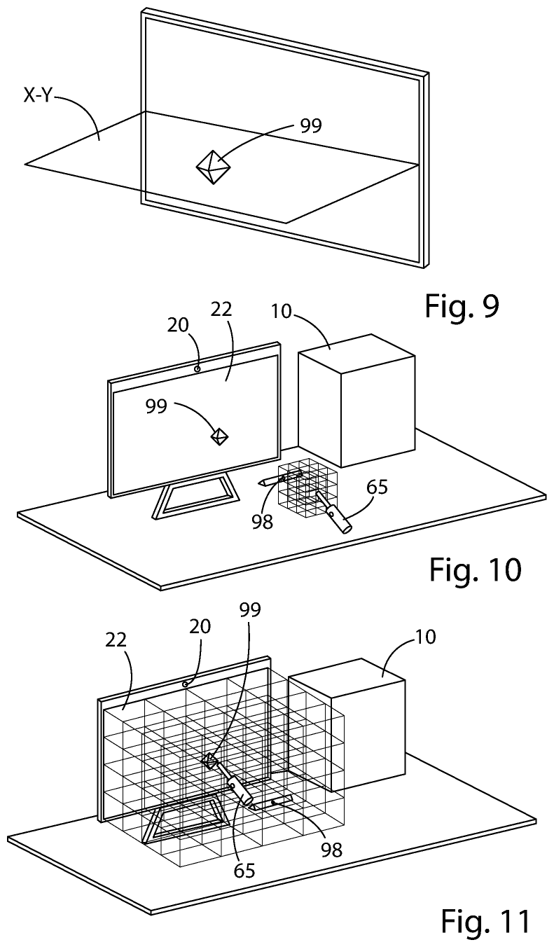

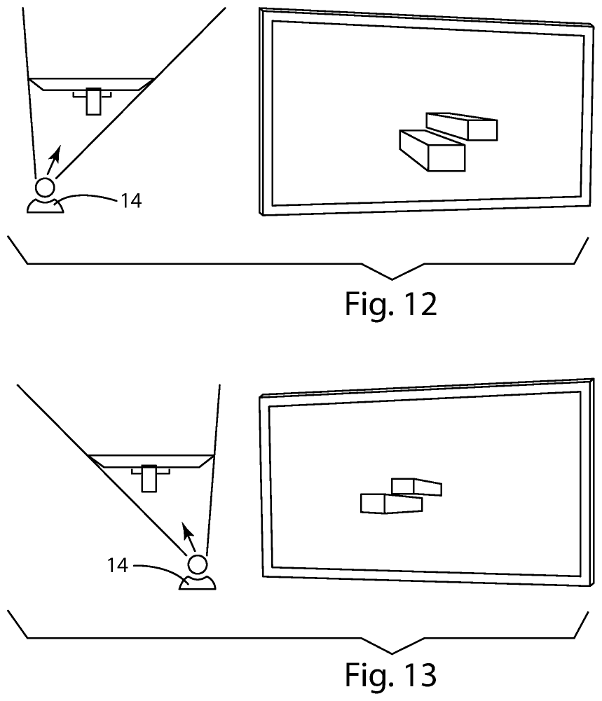

FIG. 5 shows a representative example of a 3D mouse 55 suitable for use with the display based mixed-reality device disclosed herein. The mouse 55 is similar to a conventional mouse but has an extra button 56 on the side for adjustment of a 3D cursor in a perceived 3^{rd} dimension on the display. That is, a traditional mouse allows users to move a cursor on a 2D surface, although some software applications such as those for 3D modelling and 3D gaming require 3-dimensional input. This creates a gap between 2D input devices and 3D software applications. The 3D mouse servers to merge the gap by allowing users to control the cursor in three dimensions. In accordance with one embodiment, the multi-planar mouse tracks its own movement by a light-emitting diode (LED), in which light is reflected off the surface onto a receiver made of complementary metal-oxide semiconductor (CMOS) sensors. FIG. 7 shows a typical location of the 3D mouse with respect to the computer and the display. A user can perform right-click and left-click actions by pressing on the left button and the right button, respectively. In addition, the multi-planar mouse controls a cursor in three dimensions. When the user moves the multi-planar mouse on a physical surface, the 3D cursor will move in either an X-Y (FIG. 9) or X-Z plane (FIG. 8). The user can toggle between the two planes using a designated button 56 on the multi-planar mouse. This multi-planar mouse advantageously controls a 3D cursor that represents input positions in X, Y and Z directions. This allows a user to input 3D data with ease and comfort as the hand remains rested on the multi-planar mouse.

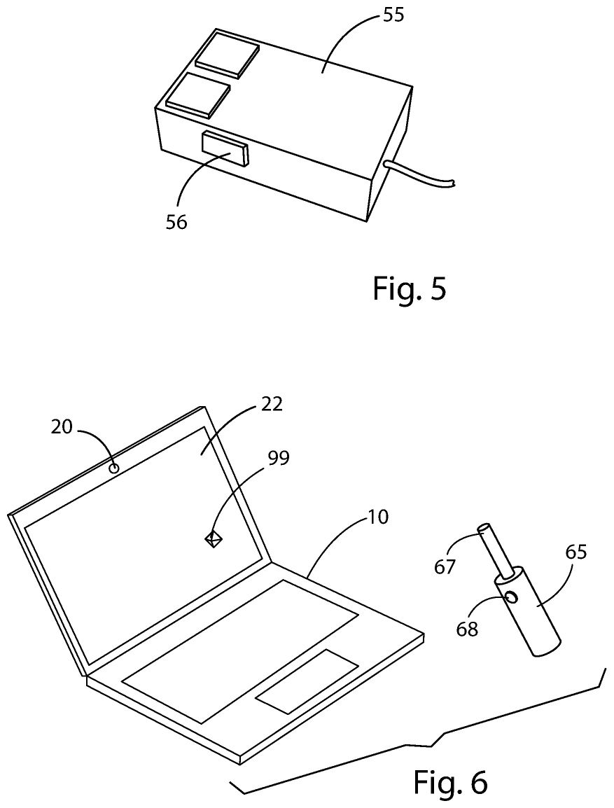

FIG. 6 shows another image control device, a wand 65, having a wand tip 67. As with the 3D mouse, the wand 65 can be used to control the 3D cursor and edit the holographic image. The wand 65 can be held in the viewer's/user's hand. Alternatively, as shown in FIG. 10, the wand can be placed such that the user does not have to carry it around. A wand relative tracking camera 98 may be provided to observe a wand location and transmit that to corresponding movement of the 3D cursor or adjustment of the holographic image/3D image as needed.

FIG. 10 is an overview of the multi-space 3D coordinate input system being used with a computer in accordance with one embodiment. The multi-space 3D input system comprises of a 3D wand, a local space tracking camera and a relative space tracking camera 98. FIG. 6 shows an isolated view of a 3D wand. The 3D wand comprises a handle section, a wand tip 67 and one or more control buttons 68. The handle section is for a user to hold the device. The buttons allow a user to send commands to the rest of the display based mixed-reality device. The tip emits the infrared light which is processed by the local space tracking camera and the relative space tracking camera to obtain the local 3D positions of the wand's tip. The local 3D positions are used for interacting with 3D models. The 3D wand can also contain a gyroscope to obtain its current orientation and a buzzer which provides haptic feedback to users when the wand's tip positions collide with 3D models for interaction.

FIG. 11 shows the relative tracking camera tracking the tip of the 3D wand in a 3D space (represented by a 3-dimensional mesh). The current position of the wand's tip is translated and represented by a virtual octahedron floating in front of a display. The octahedron is controlled by the movement of the wand's tip within the mesh. Note that position of the octahedron here is a relative position, not the actual position of an octahedron. In FIG. 11 the local space tracking camera tracks the tip of the 3D wand in a 3D space (represented by another 3-dimensional relative position mesh 66). The changes in position of the wand's tip within the relative position mesh is an actual position of the tip (represented by the virtual octahedron floating in front of a display which is used to direct the 3D cursor to interact with 3D models. To operate the multi-space 3D coordinate input system, a user holds the 3D wand on the handle and points the tip of the wand either in front of the local space tracking camera or the relative space tracking camera. The user can press the buttons on the 3D wand to send input commands to interact with the computer system. When the tip of the wand is placed in front of the local space tracking camera, the camera estimates the position of the wand's tip, which is the actual current positions of the tip and is used directly to control the 3D cursor (represented by the octahedron). This makes the 3D cursor appear at the tip of the wand. This method is referred to as a direct manipulation mode, in which the wand's tip can directly manipulate 3D objects in front of the display. When the tip of the 3D wand is placed in front of the relative space tracking camera, the camera estimates the position of the tip, which is translated into the relative position of the 3D cursor. This method is referred to as a relative manipulation method, in which the 3D cursor is controlled by the wand as if it is being puppeteered. The user can move the wand between the cameras to change the spaces at any time. The system will automatically detect the camera that is supposed to be operating. This allows the user to simultaneously switch between the two manipulation techniques. Whenever the 3D cursor hits and/or interacts with computer-generated objects in the operating 3D space, the 3D wand may vibrate to provide the haptic feedback to the user. The tactile and haptic feedback features allow a user to receive physical tactile feedback by holding a physical device and to sense haptic feedback from interactions.

The system as disclosed herein allows a user to control a 3D cursor in a 3D environment. The direct manipulation feature gives an additional sense of immersion to the user as if he/she can directly control the 3D cursor. The relative manipulation feature allows a user to control the 3D cursor with reduced movement. This offers the user the comfort when using the 3D wand and enables operation of the device over a longer period of time. Unlike known interaction techniques that rely on hand gestures, the 3D wand provides tactile and haptic feedback which can increase the level of comfort and the sense of immersion. The mode switching feature allows the user to switch between the two interaction modes, which is intuitive and easy when interacting with the system.

To summarize the capabilities, of the 3D mouse and the 3D wand, either the 3D mouse or the 3D wand can be used to control the 3D cursor moveable on the display in response to movement of the one of the 3D mouse and the 3D wand. The adjustable image and the cursor are shown on the display in a virtual 3D environment having three virtual dimensions, and either the mouse or the wand interacts with and controls movement of the cursor and the adjustable image in all three of the virtual dimensions of the virtual 3D environment. Optionally a wand tracking camera which tracks movement of the wand is provided, and the processor is adapted to convert movement of the wand to perceived movement of the cursor on the display. The relative position mesh defines a volume, and when a tip of the wand is in the relative position mesh a signal is sent to the cursor to move the cursor in response to movement of the wand.

The device disclosed herein can comprise, for example, a fish tank virtual reality presentation on a display, face recognition, face tracking, generating 2D or 3D perspective-corrected images, and 3D model reconstruction. Data may be transmitted between computers, either 2D data or 3D data, and one or more of several interaction techniques may be used, including a 3D mouse, an image-based technique (like recognizing a hand swiping in front of a camera and associating it with a slapping gesture, for example), Leap motion, stylus, wand and regular mouse. Advantages of the device disclosed herein can be product design in a holographic setting, as well as collaboratively work over a 3D model remotely in real time.

The 3D wand tracker can track the tip of the wand while it is located in a local work space which located in front of a display. The position of the virtual 3D cursor can be continuously updated based on the position of the tip of the pointing device in the local space. The tracker/sensor that tracks a tip of a pointing device while it is located in a relative work space, and the relative work space can be located outside of a display. The position of a virtual 3D cursor can be updated based on the position of the tip of the pointing device in the relative work space; and the tracker sensor can identify whether the tip of a point device is located in a local work space or a relative work space.

Other ways of presenting 3D images and 3D objects will be readily apparent to those skilled in the art given the benefit of this disclosure. For example, a holographic image of an object can be displayed on the display, and a 3D image of a face of a person may also be displayed to the viewer. The holographic image may be adjustable in response to movement of the viewer of the object and the face, while the face may be continuously adjustable in real-time in response to movement of the person. The person may be remote from the viewer.

From the foregoing disclosure and detailed description of certain embodiments, it will be apparent that various modifications, additions and other alternative embodiments are possible without departing from the true scope of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A display based mixed-reality device for a viewer to view an adjustable holographic image of an object, comprising, in combination:
a first computer having a display, a first camera, and a processor having a data set used for displaying the adjustable image on the display; and
a tracker of the viewer which tracks a position of the viewer to create position data corresponding to a face of the user, wherein the position data is compared to reference data from a facial database to obtain the viewer position;
wherein the adjustable image of the object is continuously adjusted in response to a change in the viewer position.

2. The display based mixed-reality device of claim 1 further comprising a noise reducer adapted to reduce random variation of at least one of brightness and color information in the adjustable image.

3. The display based mixed-reality device of claim 2 wherein the noise reducer determines whether the viewer is one of moving and static.

4. The display based mixed-reality device of claim 2 wherein a sampled viewer position is the viewer position sampled at a number of times per second, and the noise reducer reduces noise by creating interpolated viewer positions between one or more of the sampled viewer positions thereby increasing a total number of viewer positions used for adjustment of the adjustable image.

5. The display based mixed-reality device of claim 1 wherein the adjustable image is a holographic image comprising one of an anaglyphs based on a 2D display, a passive 3D display, an active 3D display, a parallax barrier 3D display, a lenticular lens 3D display, and a light field display.

6. The display based mixed-reality device of claim 1 wherein a single camera is used to calculate adjustment of the adjustable image, and the adjustable image is movable separate from the adjustment of the adjustable image made in response to change of the viewer position.

7. The display based mixed-reality device of claim 1 further comprising an anti-ghoster for reducing a ghosting effect on the adjustable image comprising using the viewer position to calculate an estimated ghosting pattern, comparing the estimated ghosting pattern with a model ghosting pattern to generate an anti-ghosting pattern, and applying the anti-ghosting pattern to the adjustable image to reduce the ghosting effect on the adjustable image.

8. The display based mixed-reality device of claim 1 wherein the tracker tracks eyes of the viewer.

9. The display based mixed-reality device of claim 1 further comprising:
an image creator comprising a basic image of the object; and
a 3D reconstructor which uses the basic image to create 3D model data, the 3D model data is sent to the first computer, and the object is a 3D image created on the display using the 3D model data.

10. The display based mixed-reality device of claim 9 wherein the 3D reconstructor creates the 3D model data by one of comparing the basic image to a standard model of the object to create 3D model data, such that the 3D model data comprises data interpolated from the standard model, and extrapolates the 3D model data from the basic image.

11. The display based mixed-reality device of claim 10 wherein the 3D image is continuously updated on the display in response to movement of the object.

12. The display based mixed-reality device of claim 11 wherein the object is a human head, and the standard model is data corresponding to a standard human head.

13. The display based mixed-reality device of claim 12 wherein the basic image of the head is captured on a second camera on a second computer operatively connected to the first computer.

14. The display based mixed-reality device of claim 9 wherein the 3D model data is storable on the processor for use on the display at a later time.

15. The display based mixed-reality device of claim 1 further comprising one of a 3D mouse and a 3D wand, and the adjustable image further comprises a cursor moveable on the display in response to movement of the one of the 3D mouse and the 3D wand;
wherein the adjustable image and the cursor are shown on the display in a virtual 3D environment having three virtual dimensions, and one of the mouse and the wand controls movement of cursor the in all three of the virtual dimensions of the virtual 3D environment.

16. The display based mixed-reality device of claim 15 wherein the one of the mouse and the wand interact with the adjustable image.

17. The display based mixed-reality device of claim 16 further comprising a wand tracking camera which tracks movement of the wand, and the processor is adapted to convert movement of the wand to movement of the cursor.

18. The display based mixed-reality device of claim 17 further comprising a relative position mesh defining a volume, and when a tip of the wand is in the relative position mesh a signal is sent to the cursor to move the cursor in response to movement of the wand.
